(19) United States
(12) Patent Application Publication
(10) Pub. No.: US 2017/0195617 A1
(43) Pub. Date: Jul. 6, 2017

(54) Image processing method and electronic device

(71) Applicants: LE HOLDINGS (BEIJING) CO., LTD., BEIJING (CN); LEMOBILE INFORMATION TECHNOLOGY (BEIJING) CO., LTD, Beijing (CN)

(72) Inventor: Liangxiao ZHANG, Beijing (CN)

(21) Appl. No.: 15/241,835

(22) Filed: Aug. 19, 2016

Related U.S. Application Data
(63) Continuation of application No. PCT/CN2016/088732, filed on Jul. 5, 2016.

(30) Foreign Application Priority Data
Dec. 18, 2015 (CN) 2015109590545

(51) Int. Cl. H04N 5/775; H04N 19/44; H04N 5/77

(52) U.S. Cl. CPC H04N 5/775; H04N 5/77; H04N 19/44

(57) ABSTRACT

The present application discloses an image processing method and an electronic device. In embodiments of the present application, an operation mode of Miracast is obtained, where the operation mode of Miracast includes a real-time mode or a non real-time mode; projection parameters are obtained according to the operation mode of Miracast, where the projection parameters include at least either a projection resolution or a projection encoding rate; by using the said projection parameters, processing an image to be encoded, which is obtained by a transmitting end, to obtain a data stream of projected video; and transmitting the said data stream of projected video to a receiving end, such that the said receiving end outputs the said data stream of projected video.

### CROSS REFERENCE TO RELATED APPLICATIONS

The present application is a continuation of PCT application which has an application number of PCT/CN2016/088732 and was filed on Jul. 5, 2016. This application is based upon and claims priority to the Chinese Patent Application NO. 2015109590545, titled “image processing method and device”, filed on Dec. 18, 2015 with the State Intellectual Property Office of People's Republic of China, the contents of which are incorporated by reference herein in its entirety.

### TECHNICAL FIELD

The present application relates to the technical field of communication, and in particular to an image processing method and an electronic device.

### BACKGROUND

Generally, that video content is shared wirelessly between terminals can be realized via wireless display function (Miracast) technology. In a Miracast system, video content displayed by a terminal may be projected to another terminal for playing, the terminal which projects the video content is referred to as a transmitting end, i.e., a Source end, and the terminal to which the video content is projected is referred to as a receiving end, i.e., a Sink.

However, due to the fact that users have different real-time demands with respect to content of shared images, for example watching TV programs or participating in video games, it is therefore a matter of urgency—to provide an image processing method to satisfy different real-time demands for content of shared images.

### SUMMARY

According to multiple aspects of the present application, an image processing method and an electronic device are provided, to satisfy different real-time demands for content of shared images.

According to an aspect of an embodiment of the present application, an image processing method is provided, which includes:

obtaining an operation mode of wireless display function of Miracast, where the said operation mode of Miracast includes a real-time mode or a non real-time mode;

obtaining projection parameters according to the operating mode of Miracast, where the said projection parameters include at least either a projection resolution or a projection encoding rate;

processing an image to be encoded, which is obtained by a transmitting end, to obtain by utilizing the said projection parameters a data stream of projected video; and

transmitting the said data stream of projected video to a receiving end, such that the said receiving end outputs the said data stream of projected video.

As a second aspect, embodiments of the present application provides an electronic device, which includes:

at least one processor; and

a memory communicably connected with the said at least one processor; wherein

the said memory stores instructions executable by the said at least one processor, wherein execution of the instructions by the said at least one processor causes the at least one processor to:

obtain the operation mode of a wireless display function of Miracast, where the said the said operation mode of Miracast includes a real-time mode or a non real-time mode;

obtain projection parameters according to the said operating mode of Miracast, wherein the said projection parameters at least include either a projection resolution or a projection encoding rate;

by using the said projection parameters to be encoded, process an image, which is obtained by a transmitting end, to obtain a data stream of projected video; and

transmit the said data stream of projected video to a receiving end, such that the said receiving end outputs the said data stream of projected video.

As third aspect, the present application provides a non-transitory computer-readable storage medium, wherein the said non-transitory computer-readable storage medium stores executable instructions, the said computer can execute the instructions in order to:

obtain the operation mode of a wireless display function of Miracast, where the said the said operation mode of Miracast includes a real-time mode or a non real-time mode;

obtain projection parameters according to the said operating mode of Miracast, wherein the said projection parameters at least include either a projection resolution or a projection encoding rate;

by using the said projection parameters, process an image to be encoded, which is obtained by a transmitting end, to obtain a data stream of projected video; and

transmit the said data stream of projected video to a receiving end, such that the said receiving end outputs the said data stream of projected video.

It can be known according to the technical solution that, in embodiments of the present application, the operation mode of Miracast is obtained, where the said operation mode of Miracast includes a real-time mode or a non real-time mode; the projection parameters are obtained according to the operation mode of Miracast, where the projection parameters include at least one of the projection resolution and the projection encoding rate; and the image to be encoded, which is obtained by the transmitting end, is processed using the projection parameters to obtain a data stream of projected video, such that the data stream of projected video is transmitted to the receiving end and the receiving end outputs the data stream of projected video. Since the image to be encoded, which is obtained by the transmitting end, can be processed using different projection parameters according to the operation mode of Miracast, different real-time demands for content of shared images can be satisfied.

The above illustration is only an outline of the technical solutions of the present application, and the present application can be implemented according to content of the description so that implementation of the technical solutions of the present application can be understood more clearly. In addition, in order to make the above and other objectives, features and advantages of the present application become more clear and easier to understand, embodiments of the present application are particularly included hereinafter.

### BRIEF DESCRIPTION OF THE DRAWINGS

By reading the detailed description of preferred embodiments hereinafter, other advantages and benefits will become clearer for those skilled in the art. Drawings are only used to illustrate preferred embodiments of the present application and are not intended to limit the disclosure. The same reference numeral represents like elements throughout. In the drawings:

FIG. 1 is a schematic flow chart of an image processing method in accordance with an embodiment of the present application;

FIG. 2 is a schematic structural diagram of an image processing device in accordance with another embodiment of the present application;

FIG. 3 schematically shows a structural of hardware of an electronic device in accordance with the embodiment of the present application; and

### DETAILED DESCRIPTION

Hereinafter exemplary embodiments of the disclosure are elaborated with reference to the drawings. Although the drawings show exemplary embodiments of the disclosure, it should be understood that the disclosure may be implemented in various forms and is not limited by the embodiments prescribed herein. In contrast, the embodiments are provided such that the disclosure can be understood more thoroughly and the scope of the disclosure can be fully conveyed to those skilled in the art.

It should be noted that, a terminal where a transmitting end described in embodiments of the present application is located may include but not limited to a mobile phone, a Personal Digital Assistant (PDA), a wireless handheld device, a tablet computer, a Personal Computer (PC), an MP3 player, an MP4 player and a wearable device (for example an intelligent glasses, a smart watch and a smart bracelet) and so on. A terminal where a receiving end is located may be an output device, for example a television, a Set Top Box (STB), a projector, audio equipment, a headphone and an in-vehicle terminal and so on.

In addition, a term “and/or” herein only indicates association between associated objects, and indicates that there may be three types of relationships. For example, A and/or B may indicate that: only A exists, both A and B exist, and only B exists. In addition, a character “/” herein generally indicates a relationship of “or” between associated objects.

FIG. 1 is a schematic flow chart of an image processing method according to an embodiment of the present application.

101, an operation mode of a wireless display function (Miracast) is obtained, where the operation mode of Miracast includes a real-time mode or a non real-time mode.

102, projection parameters are obtained according to the operation mode of Miracast, where the projection parameters include at least one either a projection resolution or a projection encoding rate.

103, an image to be encoded, which is obtained by a transmitting end, is processed by using the projection parameters, in order to obtain a data stream of projected video.

104, the data stream of projected video is transmitted to a receiving end, such that the receiving end outputs the data stream of projected video.

It should be noted that, the transmitting end and the receiving end communicate with each other using the Miracast technology. In a Miracast system, a terminal which projects video content is referred to as a transmitting end, i.e., a Source end, and a terminal to which the video content is projected is referred to as a receiving end, i.e., a Sink.

It should be noted that, 101-104 may be performed by an application of a terminal where the transmitting end is located or function units for example a plug-in or a Software Development Kit (SDK) arranged in the application of the terminal where the transmitting end is located, which is not limited by the embodiment.

It should be understood that, the application may be a native app installed on the terminal or a web app of a browser installed on the terminal, which is not limited by the embodiment.

By this way the operation mode of Miracast is obtained, where the operation mode of Miracast includes a real-time mode or a non real-time mode; projection parameters are obtained according to the operation mode of Miracast, where the projection parameters include at least either a projection resolution or a projection encoding rate; by using the said projection parameters, processing an image to be encoded, which is obtained by a transmitting end, to obtain a data stream of projected video; and transmitting the said data stream of projected video to a receiving end, such that the said receiving end outputs the said data stream of projected video. Since the image to be encoded, which is obtained by the transmitting end, can be processed by using different projection parameters according to the operation mode of Miracast, different real-time demands for content of a shared image can be fulfilled.

Optionally, in a possible implementation of the present embodiment, in 101, the operation mode of Miracast may be determined according to an application run on the terminal where the transmitting end is located. Specifically, it is determined whether the application run on the terminal where the transmitting end is located is in real time. If the application is in real time, for example a video player application or the like, the operation mode of Miracast is determined as a real-time mode; or if the application is not in real time, for example a video game application, the operation mode of Miracast is determined as a non real-time mode.

Optionally, in a possible implementation of the present embodiment, in 101, the operation mode of Miracast may be selected according to a user's operation instruction. Specifically, a selection interface may be output, and the selection interface includes a control indicating a real-time mode and a control indicating a non real-time mode, which are to be selected by the user. If the user operates the control indicating the real-time mode, the operation mode of Miracast is determined as a real-time mode; or if the user operates the control indicating the non real-time mode, the operation mode of Miracast is determined as the non real-time mode.

Optionally, in a possible implementation of the present embodiment, the correspondence between operation mode of Miracast and the projection parameters may be further set before 102.

The mentioned resolution refers to the number of pixels contained in an image. The higher the resolution is, the more the pixels are contained within the image, and the clearer the image is; otherwise, the lower the resolution is, the less the pixels are contained in the image, and the more blurred the image is.

The mentioned encoding rate, also referred to as bit rate, refers to the encoding speed of a video source, i.e., the number of bits transmitted in one second, generally in the unit of bps. The higher the encoding rate is, the clearer the picture becomes; otherwise, the lower the encoding rate is, the more blurred the picture becomes.

In a specific implementation, the correspondence between the non real-time mode and at least one of a non real-time projection resolution and a non real-time projection encoding rate may be set, where the non real-time projection resolution is greater than or equal to a first resolution threshold, and the non real-time projection encoding rate is greater than or equal to a first encoding rate threshold.

In this way, the non real-time projection resolution corresponding to the non real-time mode may be set as a compatible resolution as high as possible, and/or the non real-time projection encoding rate corresponding to the non real-time mode may be set as a compatible encoding rate as high as possible, thereby ensuring fluency of playing of the receiving end and definition of content of the picture, and satisfying the non real-time requirement for content of a shared image.

In another specific implementation, the correspondence between the real-time mode and at least one of a real-time projection resolution and a real-time projection encoding rate may be set, where the real-time projection resolution is less than a second resolution threshold and the real-time projection encoding rate is less than a second encoding rate threshold.

Wherein the said first resolution threshold can be greater than or equal to the said second resolution threshold; and the said first encoding rate threshold can be greater than or equal to the said second encoding rate threshold. It should be understood that, the thresholds may be set as empirical values or experimental values obtained by repeated verification through experiments, which are not limited by the embodiment.

In this way, the real-time projection resolution corresponding to the real-time mode is set as a compatible resolution as low as possible, and/or the real-time projection encoding rate corresponding to the real-time mode is set as a compatible encoding rate as low as possible, thereby ensuring a small delay of playing of the receiving end and satisfying the real-time requirement for content of a shared image.

In the present application, if the obtained projection parameter is a projection resolution and after the projection parameter is obtained, a series of conversion processing may be performed on an image to be encoded obtained by performing screenshot on an interface displayed on the terminal where the transmitting end is located, using the obtained projection resolution, so as to obtain a projection image with the projection resolution. Then, video encoding processing is performed on the obtained projection image using a default projection encoding rate, to obtain a data stream of projected video and transmit the data stream of projected video to the receiving end for outputting.

In the present application, if the obtained projection parameter is a projection encoding rate and after the projection parameter is obtained, a series of conversion processing may be performed on an image to be encoded obtained by performing screenshot on an interface displayed on the terminal where the transmitting end is located, using a default projection resolution, so as to obtain a projection image with the projection resolution. Then, video encoding processing is performed on the obtained projection image using the obtained projection encoding rate, to obtain a data stream of projected video and transmit the data stream of projected video to the receiving end for outputting.

In the present application, if the obtained projection parameters are a projection resolution and a projection encoding rate and after the projection parameters are obtained, a series of conversion processing may be performed on an image to be encoded obtained by performing screenshot on an interface displayed on the terminal where the transmitting end is located, using the obtained projection resolution, so as to obtain a projection image with the projection resolution. Then, video encoding processing is performed on the obtained projection image using the obtained projection encoding rate, to obtain a data stream of projected video and transmit the data stream of projected video to the receiving end for outputting.

Optionally, in a possible implementation of the embodiment, decoding caching parameters may be further obtained according to the operation mode of Miracast after 101.

Before the implementation, the correspondence between the operation mode of Miracast and the decoding caching parameters can further be set.

During a specific implementation process, the correspondence between the non real-time mode and a non real-time decoding caching parameter may be set, where the non real-time decoding caching parameter is greater than or equal to a first caching threshold.

In this way, the non real-time decoding caching parameter corresponding to the non real-time mode may be configured as a compatible caching value as large as possible, thereby ensuring fluency of playing of the receiving end and definition of content of the picture, and satisfying the non real-time requirement for content of a shared image.

In another specific implementation process, the correspondence between the real-time mode and a real-time decoding caching parameter may be set, where the real-time decoding caching parameter is less than a second caching threshold.

Wherein the first caching threshold may be greater than or equal to the second caching threshold. It should be understood that, the thresholds may be set as empirical values or experimental values obtained by repeated verification through experiments, which are not limited by the embodiment.

By this way, the real-time decoding caching parameter corresponding to the real-time mode may be set as a compatible caching value as small as possible, thereby ensuring a small delay of playing of the receiving end and satisfying the real-time requirement for content of a shared image.

Accordingly, in the implementation, after the decoding caching parameter is obtained, the decoding caching parameter may be transmitted to the receiving end, such that the receiving end sets a buffer for storing the data stream of projected video by using the decoding caching parameter, and outputs the data stream of projected video within the buffer.

It should be noted that, in the present application, data communication between the transmitting end and the receiving end is performed based on a created Session and using a Real-Time Streaming Protocol (RTSP).

In the embodiment, the operation mode of Miracast is obtained, where the operation mode of Miracast includes the real-time mode or the non real-time mode; the projection parameters are obtained according to the operation mode of Miracast, where the projection parameters include at least one of the projection resolution and the projection encoding rate; and the image to be encoded obtained by the transmitting end is processed using the projection parameters to obtain the data stream of projected video, such that the data stream of projected video can be transmitted to the receiving end, and the receiving end outputs the data stream of projected video. Since the image to be encoded obtained by the transmitting end can be processed using different projection parameters according to the operation mode of Miracast, different real-time demands for content of a shared image can be satisfied.

In addition, with the technical solutions provided by the present application, the non real-time projection resolution corresponding to the non real-time mode is set as a supported resolution as high as possible, and/or the non real-time projection encoding rate corresponding to the non real-time mode is set as a supported encoding rate as high as possible, and/or the non real-time decoding caching parameter corresponding to the non real-time mode is set as a supported caching value as large as possible, thereby ensuring fluency of playing of the receiving end and definition of content of the picture, and satisfying the non real-time requirement for content of a shared image.

In addition, with the technical solutions provided by the present application, the real-time projection resolution corresponding to the real-time mode is set as a supported resolution as low as possible, and/or the real-time projection encoding rate corresponding to the real-time mode is set as a supported encoding rate as low as possible, and/or the real-time decoding caching parameter corresponding to the real-time mode is set as a supported caching value as small as possible, thereby ensuring a small delay of playing of the receiving end and satisfying the real-time requirement for content of a shared image.

In addition, with the technical solutions provided by the present application, the image to be encoded obtained by the transmitting end can be processed using appropriate projection parameters according to the operation mode of Miracast, thereby greatly improves users' experience.

It should be noted that, for the method embodiments described above, the method embodiments are described as a combination of a series of actions for simplicity of the description. However, those skilled in the art should know that the present application is not limited by the order of the described actions, since some steps may be performed in other orders or simultaneously according to the present application. In addition, those skilled in the art should also know that the embodiments described in the description each are preferred embodiments, and the described actions and modules are not necessary for the present application.

In the embodiments, each embodiment lays emphasis on differences in relation to other embodiments, and a part not described in detail in a particular embodiment may be referred to associated description in other embodiments.

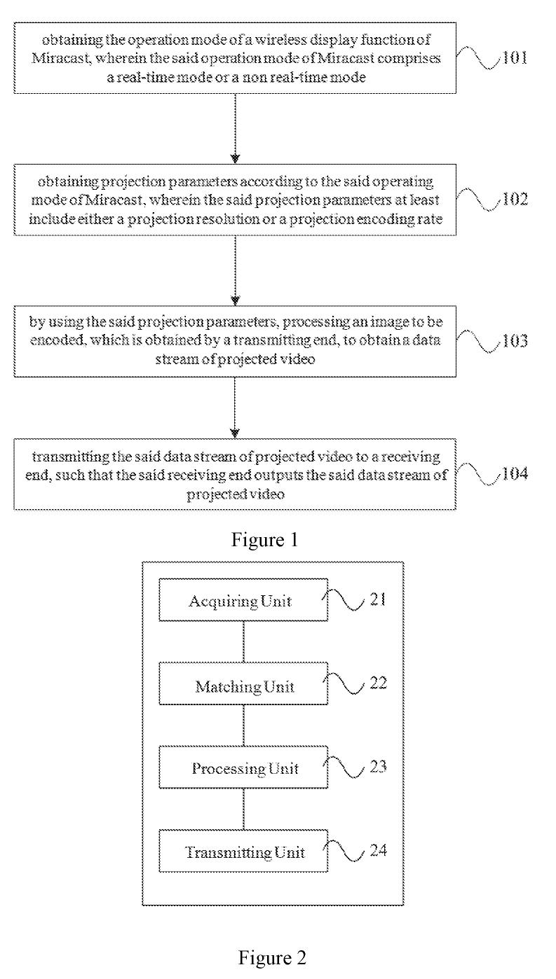

FIG. 2 is a schematic structural diagram of an image processing device in accordance with another embodiment of the present application. As shown in FIG. 2, the image processing device in the embodiment may include an acquiring unit 21, a matching unit 22, a processing unit 23 and a transmitting unit 24. The acquiring unit 21 is configured to acquire an operation mode of wireless display function of Miracast, where the operation mode of Miracast includes a real-time mode or a non real-time mode. The matching unit 22 is configured to obtain projection parameters according to the operation mode of Miracast, where the projection parameters include at least one of a projection resolution and a projection encoding rate. The processing unit 23 is configured to process an image to be encoded obtained by a transmitting end using the projection parameters, to obtain a data stream of projected video. The transmitting unit 24 is configured to transmit the data stream of projected video to a receiving end, such that the receiving end outputs the data stream of projected video.

It should be noted that, the image processing device in the embodiment may be an application of a terminal where the transmitting end is located, or function units for example a plug-in or a Software Development Kit (SDK) arranged in the application of the terminal where the transmitting end is located, which is not limited by the embodiment.

It should be understood that, the application may be a native app installed on the terminal or a web app of a browser installed on the terminal, which is not limited by the embodiment.

Optionally, in a possible implementation of the embodiment, the matching unit 22 may be further configured to set the correspondence between the said operation mode of Miracast and the said projection parameters.

Specifically, the matching unit 22 may be configured to set the correspondence between the non real-time mode and at least one of a non real-time projection resolution and a non real-time projection encoding rate, where the non real-time projection resolution is greater than or equal to a first resolution threshold and the non real-time projection encoding rate is greater than or equal to a first encoding rate threshold; and/or set a correspondence between the real-time mode and at least one of a real-time projection resolution and a real-time projection encoding rate, where the real-time projection resolution is less than a second resolution threshold and the real-time projection encoding rate is less than a second encoding rate threshold. In which, the first resolution threshold is greater than or equal to the second resolution threshold, and the first encoding rate threshold is greater than or equal to the second encoding rate threshold.

Optionally, in a possible implementation of the embodiment, the matching unit 22 may be further configured to obtain decoding caching parameters according to the operation mode of Miracast.

Before the implementation, the matching unit 22 may be further configured to set the correspondence between the said operation mode of Miracast and the said decoding caching parameters.

Specifically, the matching unit 22 may be configured to set the correspondence between the non real-time mode and the non real-time decoding caching parameters, where the non real-time decoding caching parameter is greater than or equal to a first caching threshold; and/or set a correspondence between the real-time mode and the real-time decoding caching parameter, where the real-time decoding caching parameter is less than a second caching threshold. Wherein the first caching threshold is greater than or equal to the second caching threshold.

Accordingly, the transmitting unit 24 may be further configured to transmit the decoding caching parameters to the receiving end, such that the receiving end configures a buffer for storing the data stream of projected video using the decoding caching parameters, and outputs the data stream of projected video within the buffer.

It should be noted that, the method in the embodiment corresponding to FIG. 1 may be implemented by the image processing device provided in the embodiment. Detailed description may be referred to associated content in the embodiment corresponding to FIG. 1, which is not described here in detail.

In the embodiment, the acquiring unit obtains the operation mode of Miracast, where the operation mode of Miracast includes the real-time mode or the non real-time mode; the matching unit obtains the projection parameters according to the operation mode of Miracast, where the projection parameters include at least one of the projection resolution and the projection encoding rate; and the processing unit processes the image to be encoded obtained by the transmitting end using the projection parameters to obtain the data stream of projected video, such that the transmitting unit can transmit the data stream of projected video to the receiving end and the receiving end outputs the data stream of projected video. Since the image to be encoded obtained by the transmitting end is processed using different projection parameters according to the operation mode of Miracast, different real-time demands for content of a shared image can be satisfied.

In addition, with the technical solutions provided by the present application, the non real-time projection resolution corresponding to the non real-time mode is set as a supported resolution as high as possible, and/or the non real-time projection encoding rate corresponding to the non real-time mode is set as a supported encoding rate as high as possible, and/or the non real-time decoding caching parameter corresponding to the non real-time mode is set as a supported caching value as large as possible, thereby ensuring fluency of playing of the receiving end and definition of content of the picture, and satisfying the non real-time requirement for content of a shared image.

In addition, with the technical solutions provided by the present application, the real-time projection resolution corresponding to the real-time mode is set as a supported resolution as low as possible, and/or the real-time projection encoding rate corresponding to the real-time mode is set as a supported encoding rate as low as possible, and/or the real-time decoding caching parameter corresponding to the real-time mode is set as a supported caching value as small as possible, thereby ensuring a small delay of playing of the receiving end and satisfying the real-time requirement for content of a shared image.

In addition, with the technical solutions provided by the present application, the image to be encoded obtained by the transmitting end can be processed using appropriate projection parameters according to the operation mode of Miracast, thereby greatly improving users' experience.

An embodiment of the present application provides a non-transitory computer-readable storage medium, wherein the said non-transitory computer-readable storage medium stores executable instructions, the said computer can execute the instructions of any one of the methods for processing images, which are prescribed in the above mentioned embodiments.

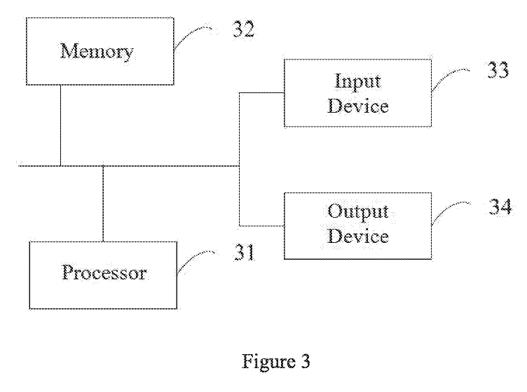

An embodiment of the present application further provides an electronic device, FIG. 3 shows a structural view of the hardware associated with the said electronic device which comprises:

at least one processor 31 which is shown in FIG. 3 as an example, and a memory 32.

The electronic device further comprises: an input device 33 and an output device 34.

Processor 31, memory 32, input device 33 and output device 34 can be connected by BUS or other methods, and BUS connecting is showed in FIG. 3 as an example.

Memory 32 can be used for storing non-transitory software program, non-transitory computer executable program and modules as a non-transitory computer-readable storage medium, such as corresponding program instructions/modules for the methods for playing live video mentioned by embodiments of the present disclosure (such as shown in FIG. 2, acquiring unit 21, matching unit 22, processing unit 23 and transmitting unit 24). Processor 31 performs kinds of functions and playing live video of the electronic device by executing non-transitory software program, instructions and modules which are stored in memory 32, thereby realizes the methods for playing live video mentioned by embodiments of the present disclosure.

Memory 32 can include program storage area and data storage area, thereby the operating system and applications required by at least one function can be stored in program storage area and data created by using the device for playing live video can be stored in data storage area. Furthermore, memory 32 can include high speed Random-access memory (RAM) or non-volatile memory such as magnetic disk storage device, flash memory device or other non-volatile solid state storage devices. In some embodiments, memory 32 can include long-distance setup memories relative to processor 31, which can communicate with the device for playing live video by networks. The examples of said networks are including but not limited to Internet, Intranet, LAN, mobile Internet and their combinations.

Input device 33 can be used to receive inputted number, character information and key signals causing user configures and function controls of the device for playing live video. Output device 34 can include a display screen or a display device.

The said module or modules are stored in memory 32 and perform the methods for playing live video when executed by one or more processors 31.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

1-14. (canceled)

15. An image processing method, comprising:
obtaining the operation mode of a wireless display function of Miracast, wherein the said operation mode of Miracast comprises a real-time mode or a non real-time mode;
obtaining projection parameters according to the said operating mode of Miracast, wherein the said projection parameters at least include either a projection resolution or a projection encoding rate;
by using the said projection parameters, processing an image to be encoded, which is obtained by a transmitting end, to obtain a data stream of projected video; and
transmitting the said data stream of projected video to a receiving end, such that the said receiving end outputs the said data stream of projected video.

16. The method according to claim 15, wherein prior to obtaining projection parameters according to the said operating mode of Miracast, the method comprises:
configuring the correspondence between the said operation mode of Miracast and the said projection parameters.

17. The method according to claim 16, wherein the said configuring the correspondence between the said operation mode of Miracast and the said projection parameters comprises:
configuring the correspondence between the non real-time mode and at least either a non real-time projection resolution or a non real-time projection encoding rate, wherein the said non real-time projection resolution is greater than or equal to a first resolution threshold, and the said non real-time projection encoding rate is greater than or equal to a first encoding rate threshold; and/or
configuring the correspondence between the real-time mode and at least either a real-time projection resolution or a real-time projection encoding rate, wherein the said real-time projection resolution is less than a second resolution threshold, and the said real-time projection encoding rate is less than a second encoding rate threshold; wherein
the said first resolution threshold is greater than or equal to the said second resolution threshold; and
the said first encoding rate threshold is greater than or equal to the said second encoding rate threshold.

18. The method according to claim 15, wherein after the said obtaining operation mode of the wireless display function of Miracast, the method further comprises:
obtaining decoding caching parameters according to the said operation mode of Miracast.

19. The method according to claim 16, wherein after the said obtaining the operation mode of a wireless display function of Miracast, the method further comprises:
obtaining decoding caching parameters according to the said operating mode of Miracast.

20. The method according to claim 17, wherein, wherein after the said obtaining the operation mode of a wireless display function of Miracast, the method further comprises:
obtaining decoding caching parameters according to the said operating mode of Miracast.

21. The method according to claim 18, wherein before obtaining the decoding caching parameters according to the operation mode of Miracast, the method further comprises:
configuring the correspondence between the said operation mode of Miracast and the said decoding caching parameters.

22. The method according to claim 21, wherein the said configuring the correspondence between the said operation mode of Miracast and the said decoding caching parameters comprises:
configuring the correspondence between the non real-time mode and a non real-time decoding caching parameter, wherein the said non real-time decoding caching parameter is greater than or equal to the first caching threshold; and/or
configuring the correspondence between the real-time mode and a real-time decoding caching parameter, wherein the said real-time decoding caching parameter is less than the second caching threshold, wherein
the said first caching threshold is greater than or equal to the said second caching threshold.

23. The method according to claim 18, wherein after obtaining the decoding caching parameters according to the said operation mode of Miracast, the method further comprises:
transmitting the said decoding caching parameters to the said receiving end, such that by using the said decoding caching parameters the said receiving end configures a buffer for the purpose of storing the data stream of projected video, and outputs the data stream of projected video within the buffer.

24. An electronic device, comprising:
at least one processor; and
a memory communicably connected with the said at least one processor; wherein
the said memory stores instructions executable by the said at least one processor, wherein execution of the instructions by the said at least one processor causes the at least one processor to:
obtain the operation mode of a wireless display function of Miracast, where the said operation mode of Miracast includes a real-time mode or a non real-time mode;
obtain projection parameters according to the said operating mode of Miracast, wherein the said projection parameters at least include either a projection resolution or a projection encoding rate;
by using the said projection parameters, process an image to be encoded, which is obtained by a transmitting end, to obtain a data stream of projected video; and
transmit the said data stream of projected video to a receiving end, such that the said receiving end outputs the said data stream of projected video.

25. The electronic device according to claim 24, wherein the said processor further executes:
prior to obtaining projection parameters according to the said operating mode of Miracast, configuring the correspondence between the said operation mode of Miracast and the said projection parameters.

26. The electronic device according to claim 25, wherein the said configuring the correspondence between the said operation mode of Miracast and the said projection parameters comprises:
configuring the correspondence between the non real-time mode and at least either a non real-time projection resolution or a non real-time projection encoding rate, wherein the said non real-time projection resolution is greater than or equal to a first resolution threshold, and the said non real-time projection encoding rate is greater than or equal to a first encoding rate threshold; and/or
configuring the correspondence between the real-time mode and at least either a real-time projection resolution or a real-time projection encoding rate, wherein the said real-time projection resolution is less than a second resolution threshold, and the said real-time projection encoding rate is less than a second encoding rate threshold; wherein
the said first resolution threshold is greater than or equal to the said second resolution threshold; and
the said first encoding rate threshold is greater than or equal to the said second encoding rate threshold.

27. The electronic device according to claim 24, wherein the said processor further executes:
after the said obtaining the operation mode of the wireless display function of Miracast, obtaining decoding caching parameters according to the said operation mode of Miracast.

28. The electronic device according to claim 25, wherein the said processor further executes:
after the said obtaining the operation mode of the wireless display function of Miracast, obtaining decoding caching parameters according to the said operation mode of Miracast.

29. The electronic device according to claim 26, wherein the said processor further executes:
after the said obtaining the operation mode of the wireless display function of Miracast, obtaining decoding caching parameters according to the said operation mode of Miracast.

30. The electronic device according to claim 27, wherein the said processor further executes:
prior to the said obtaining projection parameters according to the said operating mode of Miracast, configuring the correspondence between the said operation mode of Miracast and the said decoding caching parameters.

31. The electronic device according to claim 30, wherein the said configuring the correspondence between the said operation mode of Miracast and the said projection parameters comprises:
configuring the correspondence between the non real-time mode and a non real-time decoding caching parameter, wherein the said non real-time decoding caching parameter is greater than or equal to a first caching threshold; and/or
configuring the correspondence between the real-time mode and a real-time decoding caching parameter, wherein the said real-time decoding caching parameter is less than a second caching threshold, wherein
the said first caching threshold is greater than or equal to the second said caching threshold.

32. The electronic device according to claim 27, wherein the said processor further executes:
after the said obtaining the operation mode of the wireless display function of Miracast, transmitting the said decoding caching parameters to the said receiving end, such that the said receiving end configures a buffer for the purpose of storing the data stream of projected video by using the said decoding caching parameters, and outputs the data stream of projected video within the buffer.

33. A non-transitory computer-readable storage medium, wherein the said non-transitory computer-readable storage medium can store computer-executable instructions, the said computer-executable instructions are used to:
obtain the operation mode of a wireless display function of Miracast, wherein the said operation mode of Miracast comprises a real-time mode or a non real-time mode;
obtain projection parameters according to the said operating mode of Miracast, wherein the said projection parameters at least include either a projection resolution or a projection encoding rate;
by using the said projection parameters, process an image to be encoded, which is obtained by a transmitting end, to obtain a data stream of projected video; and
transmit the said data stream of projected video to a receiving end, such that the said receiving end outputs the said data stream of projected video.

34. The non-transitory computer-readable storage medium according to claim 33, wherein prior to obtaining projection parameters according to the said operating mode of Miracast, the method comprises:
configuring the correspondence between the said operation mode of Miracast and the said projection parameters.
